(19) United States
(12) Patent Application Publication
(10) Pub. No.: US 2013/0028661 A1
(43) Pub. Date: Jan. 31, 2013

(54) Non-Rigid Product Laying Apparatus

(71) Applicant: Lee David Screaton, Missouri City, TX (US)

(72) Inventor: Lee David Screaton, Missouri City, TX (US)

(21) Appl. No.: 13/192,624

(22) Filed: Jul. 28, 2011

(51) Int. Cl. F16L 1/12

(52) U.S. Cl. 405/166

(57) ABSTRACT

An arrangement for laying non-rigid product offshore that includes a dual long grip length clamp arrangement installed vertically into a tower in a similar manner to a J-lay trolley/clamp system. The invention differs from a J-lay arrangement in that two clamps are used and the clamps are configured for use with non-rigid product, i.e. they have a long grip length in order to spread the load evenly. Each clamp is mounted on a trolley and can travel vertically up or down. The upper clamp is arranged with a distance between it and the lower clamp such that the upper clamp can lower the non-rigid product a suitable distance before the lower clamp grips the non-rigid product so as to create as close as possible continuous movement as practical.

### FIELD AND BACKGROUND OF INVENTION

The invention is generally related to the laying of product offshore and, more particularly, to an arrangement for the laying of non-rigid product.

Non-rigid product such as flexible pipe, umbilical lines, or cable is currently laid using a tensioner based system with the tensioner either mounted in a vertical tower or horizontally on the deck of the product laying vessel. The maximum overboard tension is a function of the hold back capacity and the applicable grip length when applied to the coefficient of friction of the product coating.

Rigid pipe can be laid through the J-Lay methodology whereby a clamp is used to lower sections of pipe in a regimented process of lower, weld on a new section of pipe, load, lower, weld, etc. The advantage of the clamp based J-Lay process is that high tensions can be achieved using a relatively lightweight tower arrangement due to the lowering scheme being based on multi-fall hook technology. To construct a tensioner to take similar top tensions invariably leads to a very heavy tower with an unworkably high center of gravity.

There is a winch arrangement called a “linear winch” whereby two clamps are used to linearly move cable or chain. This arrangement is used for very high tensions that would make a traditional winch arrangement too large to be viable.

Traditional solutions to higher tensions are long tensioners and bigger (therefore heavier) towers. Long tensioners are very heavy and also difficult to maintain a stiff grip surface.

### SUMMARY OF INVENTION

The present invention is directed to a dual long grip length clamp arrangement installed vertically into a tower in a similar manner to a J-lay trolley/clamp system. The invention differs from a J-lay arrangement in that two clamps are used and the clamps are configured for use with non-rigid product, i.e. they have a long grip length in order to spread the load evenly. Each clamp is mounted on a trolley and can travel vertically up or down. The upper clamp is arranged with a distance between it and the lower clamp such that the upper clamp can lower the product a suitable distance before the lower clamp grips the non-rigid product so as to create as close as possible continuous movement as practical.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which reference numerals shown in the drawings designate like or corresponding parts throughout the same:

FIG. 1 is a side view of the invention.

FIG. 2-5 illustrate the sequence of lowering a non-rigid product.

### DESCRIPTION OF THE PREFERRED EMBODIMENTS

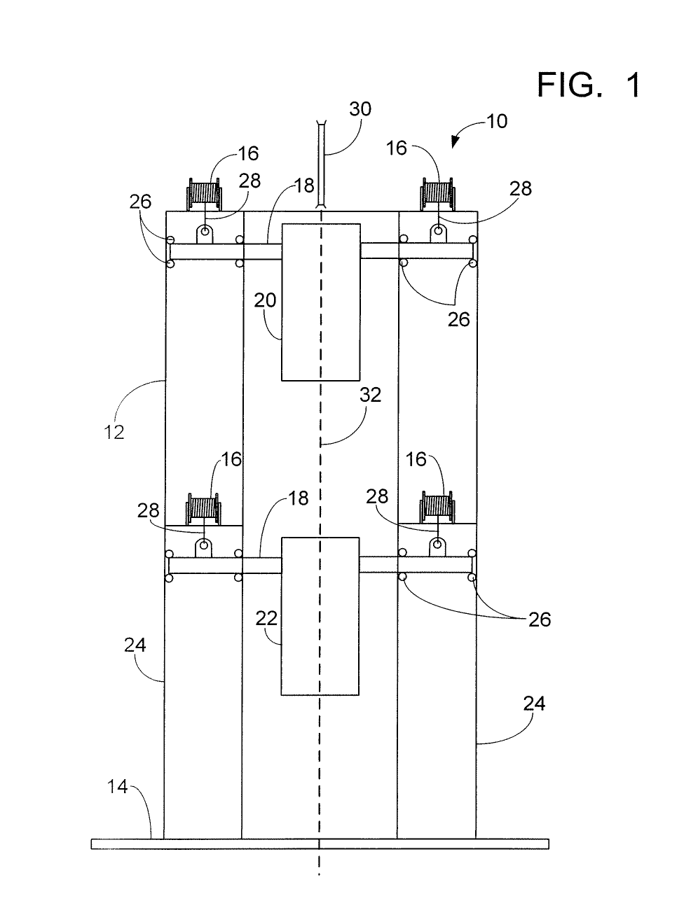

As seen in FIG. 1 the non-rigid product laying apparatus 10 is generally comprised of a tower 12 attached to the deck 14 of a product laying vessel, winches 16, trolleys 18, and upper and lower clamps 20, 22. For ease of illustration and clearly illustrating the inventive concept, it should be noted that work spaces, etc. are not shown in the drawings.

As seen in FIG. 1, the tower 12 has two legs 24 in which the trolleys 18 are movably received for vertical movement. The trolleys 18 move on wheels or rollers 26.

Upper and lower clamps 20, 22 are respectively mounted on the upper and lower trolleys 18 and are preferably long grip length clamps. Examples of long grip length clamps that have been used and are suitable for flexible product are a four meter long clamp with a capacity of 300 metric tons. By way of comparison, a ten meter long tensioner has been known to be required for up to 300 metric tons grip on a flexible product.

Winches 16 are mounted in each leg 24 of the tower 12 above each trolley 18 and have lines 28 connected to the trolleys 18.

Chute 30 is used to guide the non-rigid product 32 into upper and lower clamps 20, 22 during laying operations. For ease of reference in this Description, the term “product” will be used and understood to mean “non-rigid product” such as umbilical lines, flexible pipe, and cable, as opposed to steel pipe (coated or un-coated). While steel pipe may be bent and wound onto large reels, it is not typically considered to be a non-rigid product in the offshore industry.

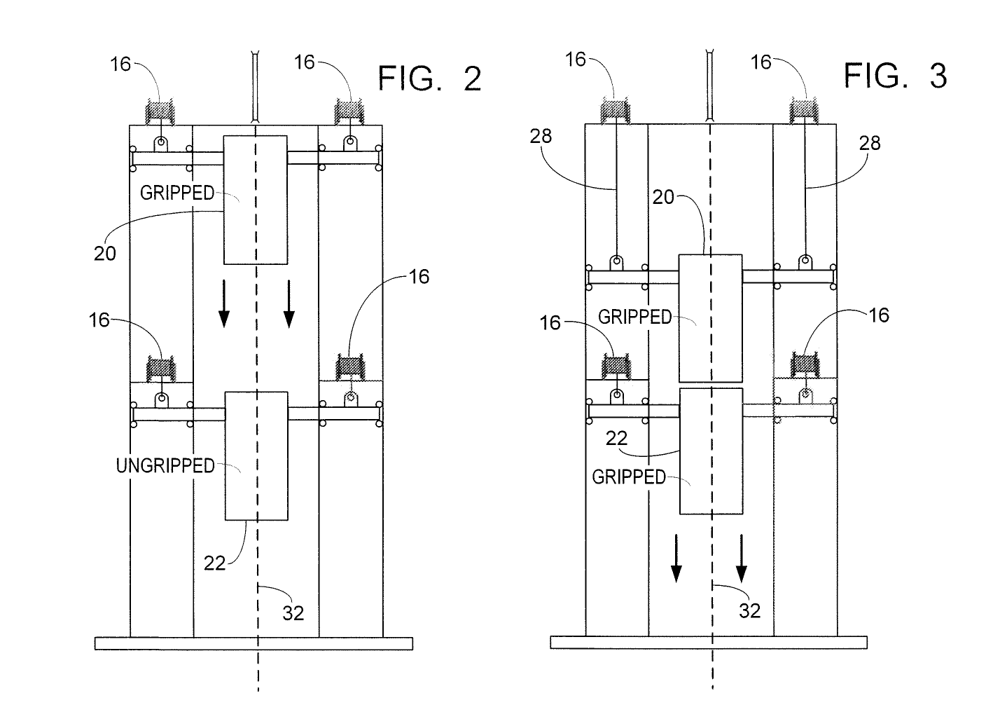

The operation of laying product 32 is illustrated in FIG. 2-5.

As seen in FIG. 2, upper clamp 20 is caused to grip the product 32 and lower clamp 22 does not grip the product 32. The winches 16 at the upper end of the tower 12 are operated to allow lowering of upper clamp 20 and subsequent movement of the product 32 downward through lower clamp 22.

As seen in FIG. 3, when the upper clamp 20 reaches the lower end of its vertical stroke immediately above the lower clamp 22, lower clamp 22 is caused to grip the product 32.

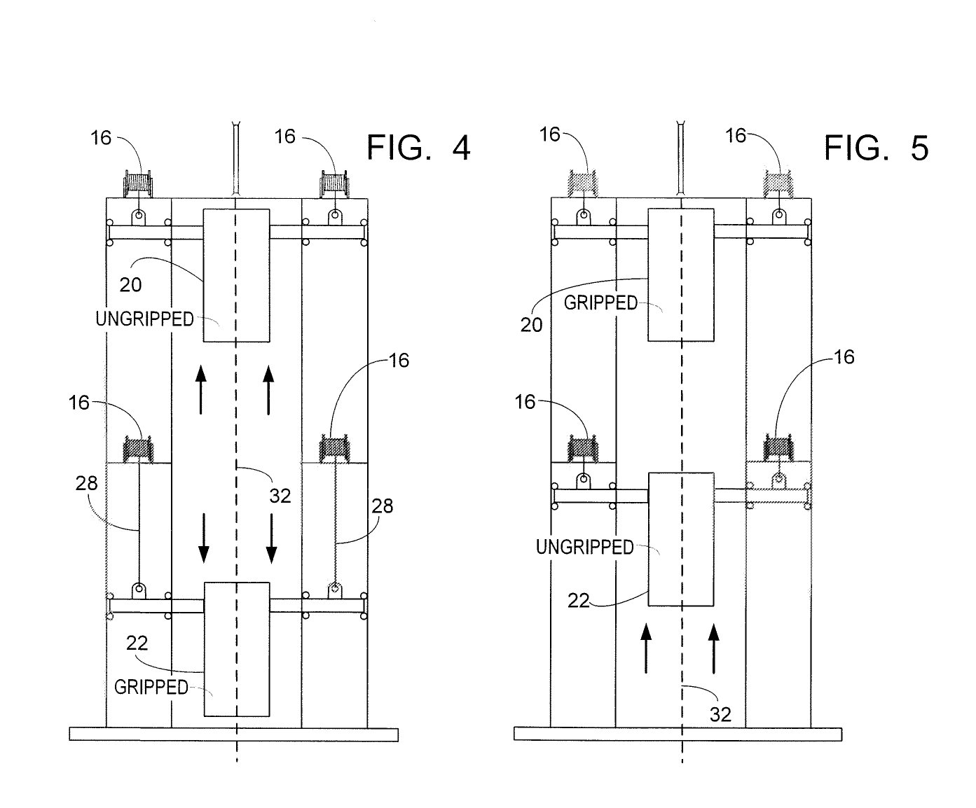

As seen in FIG. 4, the upper clamp 20 is caused to release its grip on the product 32 and the winches 16 in the middle of the tower 12 are operated to allow downward movement of the lower clamp 22 and continued movement of the product 32 while the upper clamp 20 is raised to its starting position by the winches 16 at the upper end of the tower 12.

As seen in FIG. 5, when the lower clamp 22 reaches the lower end of its stroke, the upper clamp 20 is caused to grip the product 32, the lower clamp 22 is caused to release its grip on the product 32, and the lower clamp 22 is then raised by its respective winches 16 back to its starting position. The process of laying the product 32 is then repeated.

It can be seen that with the proper timing of gripping and releasing of the clamps 20, 22 on the product 32 that the clamp that has released its grip on the product 32 may be moved in the opposite direction from the other clamp gripping and moving the product 32 to provide the most time efficient manner of laying the product 32.

The invention provides several advantages.

One advantage provided by the invention is that high tensions can be achieved in a short and lightweight tower while also providing a product friendly long-grip arrangement to allow the laying of fragile non-rigid product such as umbilical lines, flexible pipe, or cable.

Another advantage is long clamps are fundamentally simpler mechanical devices than long tensioners.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

What is claimed as invention is:

1. An apparatus on a vessel for laying non-rigid product offshore, comprising:
a. a tower mounted on the vessel;
b. at least two trolleys spaced vertically apart from each other and mounted on the tower for selective, separate, vertical movement along the tower;
c. a clamp mounted on each trolley for selectively gripping and releasing the non-rigid product; and
d. means mounted on the tower for selectively and separately moving each trolley and clamp.

2. The laying apparatus of claim 1, wherein the means for moving each trolley and clamp comprises a separate winch engaged with each trolley.

3. The laying apparatus of claim 1, wherein the clamps are long grip length clamps.

4. The laying apparatus of claim 1, wherein the vertical spacing between the two trolleys allows vertical movement of the clamps during laying operations a substantial distance relative to the size of the clamps.

5. The laying apparatus of claim 1, further comprising a chute for guiding the non-rigid product into the clamps.

6. An apparatus on a vessel for laying non-rigid product offshore, comprising:
a. a tower mounted on the vessel;
b. at least two trolleys spaced vertically apart from each other and mounted on the tower for selective, separate, vertical movement along the tower;
c. a long grip length clamp mounted on each trolley for selectively gripping and releasing the non-rigid product; and
d. at least two winches mounted on the tower for selectively and separately moving each trolley and clamp.

7. A method for laying non-rigid product from a vessel offshore, comprising the steps:
a. mounting a tower on the vessel;
b. providing upper and lower trolleys spaced vertically apart from each other on the tower and mounted for selective, separate, vertical movement along the tower;
c. providing a clamp on each trolley for selectively gripping and releasing the non-rigid product;
d. guiding the non-rigid product into the clamps;
e. gripping the non-rigid product with the clamp on the upper trolley and moving the clamp and non-rigid product downward using the trolley;
f. gripping the non-rigid product with the clamp on the lower trolley when the upper trolley reaches its lower limit and releasing the grip of the clamp on the upper trolley;
g. lowering the lower trolley and clamp while moving the upper trolley and clamp up to their starting position;
h. gripping the non-rigid product with the clamp on the upper trolley when the lower trolley reaches its lower limit and then releasing the grip on the non-rigid product by the clamp located on the lower trolley;
i. raising the lower trolley to its upper position and lowering the upper trolley to its lowest position to continue lowering of the non-rigid product; and
j. repeating the process to continuously lay the non-rigid product.
